(19) United States
(12) Patent Application Publication
(10) Pub. No.: US 2005/0270567 A1
(43) Pub. Date: Dec. 8, 2005

(54) Non-contact secure printing

(76) Inventors: Sterling Du, Kaohsiung City (TW); You-Yuh Shyr, San Jose, CA (US); Gary Wu, Fremont, CA (US); Richard Brayden, Medford, NJ (US)

Correspondence Address: WAGNER, MURABITO & HAO LLP;Third Floor, Two North Market Street, San Jose, CA, 95113, US

(21) Appl. No.: 11/137,897

(22) Filed: May 25, 2005

Related U.S. Application Data
(60) Provisional application No. 60/576,171, filed on Jun. 2, 2004.

(51) Int. Cl. G06F 15/00

(52) U.S. Cl. 358/1.15

(57) ABSTRACT

A network comprises a printer, a plurality of workstations and a portable device. A user can execute or generate a print job on the workstation. The print job will be transferred to the printer through the network. The printer will not print the print job until the user brings the portable device into proximity of printer.

### CROSS REFERENCE TO PROVISIONAL APPLICATION

This application claims priority to the co-pending provisional patent application Ser. No. 60/576,171, Attorney Docket Number 02 Micro 04.12P, entitled “Non-Contact Secure Printing,” with filing date Jun. 2, 2004, and assigned to the assignee of the present invention, which is herein incorporated by reference in its entirety.

### BACKGROUND OF THE INVENTION

1. Field of the Invention

The present invention relates to printers, and more particularly to the security of printing documents.

2. Description of the Related Art

A printer may be shared by a plurality of users utilizing a plurality of workstations of a common network. The printer may also be a multi-purpose device incorporating additional functionality such as scanning and copying capabilities. In a typical work place environment, many people may have unrestricted access to the printer, and it is not uncommon for many documents to be left unattended at the printer. While this practice may generally be acceptable in many instances, it is undesirable when such documents may contain sensitive, proprietary, or confidential information. In this situation, such printed documents left unattended may be easily viewed by people with authorized access to the printer but unauthorized access to the printed document.

Secure printing method and products are available to address the printing of secure data. Such methods may utilize a combination of software and hardware. When a user desires to print secure data to the network printer, the print job may be written to a secure location, e.g., a hard drive of a network server. When the authorized user is physically present at the network printer, the authorized user utilizes an external contact input device of the network printer to enter a particular identity code. The system then compares the identity code to an authorized code of the document waiting to print. If the system verifies that the identity code corresponds to the proper recipient of the document, the system permits the document to be printed. Accordingly, secure data is better protected as unattended secure data at a network printer is minimized.

However, current secure printing products and solutions require an external contact input device to be added to the network printer. For example, this may be a keypad, a magnetic stripe reader, a smart card reader, etc. Such external contact input devices require changes to the network printer that are difficult to fit into existing production lines. For example, such changes may require changes to the mechanical housing of the device and/or additional connectors to be added to the device to accommodate such external contact input devices.

Accordingly, there exists a need for a printing system or printer which is able to overcome the above mentioned drawbacks.

### SUMMARY OF THE INVENTION

It is an object of the present invention to provide a non-contact printer and method for printing secure documents. Specifically, the printer comprises a module for communicating with an external portable device by a non-contact approach to identify the holder of the portable device so as to print the secure document.

In order to achieve the above object, the present invention provides a network having a printer. The network further comprises a plurality of workstations and a portable device. A user can execute or generate a print job on the workstation. The print job will be transferred to the printer through the network. The printer will not print the print job until the user brings the portable device into proximity of printer.

### BRIEF DESCRIPTION OF THE DRAWINGS

Other objects, advantages, and novel features of the invention will become more apparent from the following detailed description when taken in conjunction with the accompanying drawing.

FIG. 1 is a block diagram of a network including a printer according to an embodiment of the present invention.

FIG. 2 is a perspective view of the printer shown in FIG. 1 according to an embodiment of the present invention.

FIG. 3 is a block diagram of the secure module shown in FIG. 2 according to an embodiment of the present invention.

FIG. 4 is the diagram showing a method for printing secure documents according to an embodiment of the present invention.

### DESCRIPTION OF THE EMBODIMENT

Reference will now be made in detail to the preferred embodiments of the present invention, devices and methods of printing secure documents. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

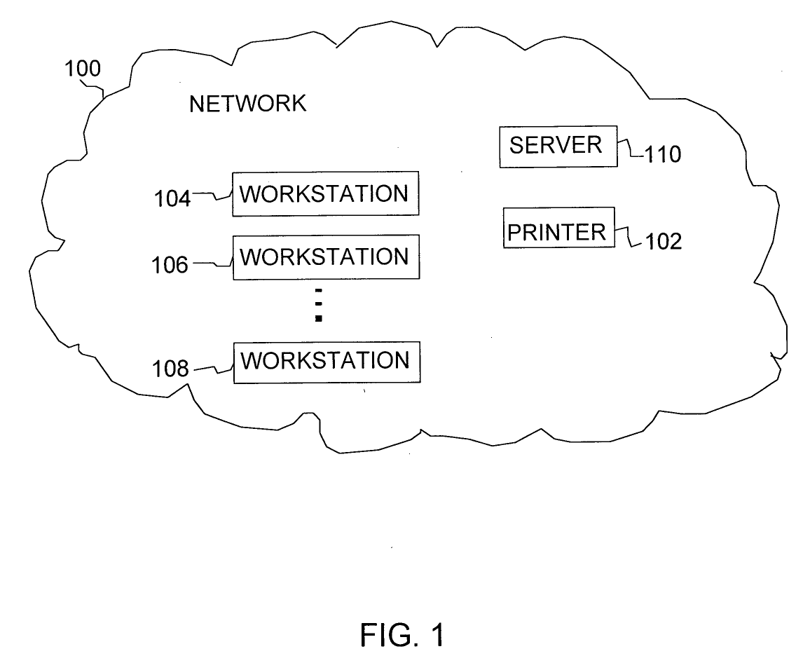

Referring to FIG. 1, a network system 100 including a printer 102 according to an embodiment of the present invention is illustrated. The network 100 has a variety of devices that may communicate with each other via a variety of communication protocols, such as Internet Protocol (IP) and Transmission Control Protocol (TCP). The network 100 includes the printer 102, a plurality of personal computers or user workstations 104, 106 . . . 108, and a server 110 that can communicate with each other to exchange information and/or commands. Although only three workstations 104, 106 . . . 108 are illustrated for clarity, any number of workstations may be in the network 100 and may be able to print documents utilizing the printer 102.

For example, in one embodiment, the network system 100 may be a local-area network (LAN), and the devices, such as user workstation 104, 106 . . . 108, a server 110 and the printer 102, are coupled to a LAN backbone for communicating with each other. The printer 102 may have printing only capabilities and/or the printer may be a multi-purpose device including other functionality as well, such as scanning, copying, fax and/or E-mail capabilities.

The network 100 is equipped with a secure printing software according to an embodiment of the present invention. According to one embodiment of the present invention, the secure printing software is installed in the workstations 104, 106 . . . 108. Alternatively, in another embodiment, the secure printing software is installed in the server 110. The secure printing software allows for communication with the printer 102 to enable secure printing of print job.

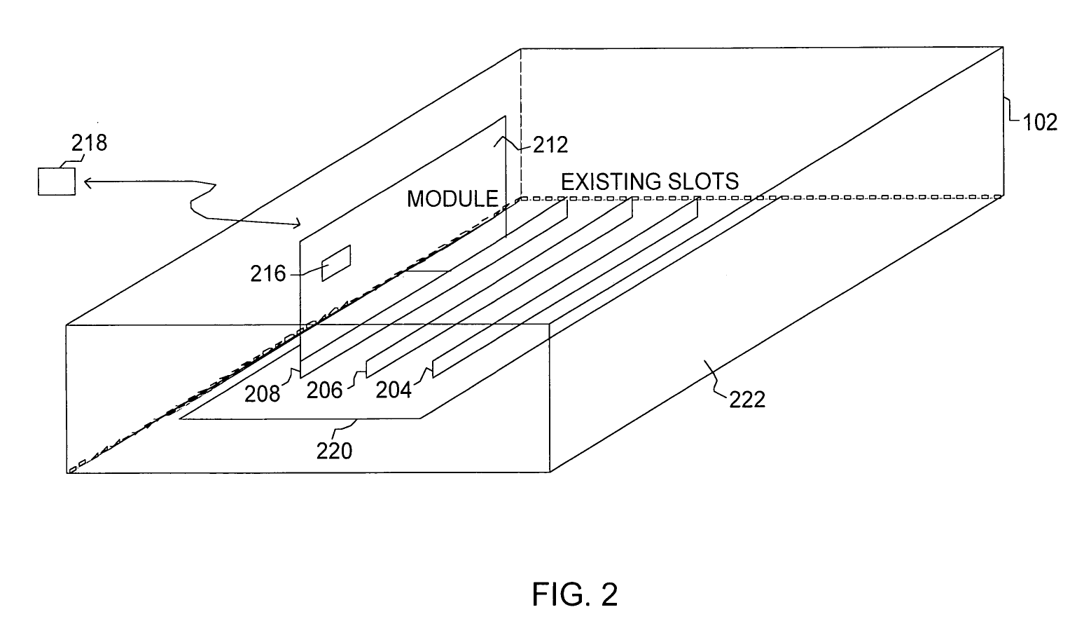

Referring to FIG. 2, the printer 102 of the network system 100 shown in FIG. 1 is illustrated, in accordance with one embodiment of the invention. The printer 102 has a printing module 222 for printing and a circuit board 220 which has a control circuit for controlling the printing module 222 and a plurality of slots 204, 206, 208. The slots 204, 206, 208 are designed to accept a particular module. In one embodiment, the slots 204, 206, 208 are memory slots configured to accept memory modules. For example, one memory module may be a dual in-line memory module (DIMM). Another memory module may be a single-in line memory module (SIMM). The memory modules that are coupled to such memory slots typically have a particular size and mating configuration to enable it to mate with associated slots. For example, the slot 208 may be a 100-pin DIMM slot commonly used in printer and desktop computer. Such modules may be separately installed, replaced, or serviced. A memory module includes one or more random access memory (RAM) chips on a separate circuit board.

According to an embodiment of the present invention, a security module 212 is equipped with non-contact communication capabilities to enable the security module 212 to communicate with a portable device 218 when the portable device 218 is within a particular proximity to the printer 102. The security module 212 is sized similarly to a typical module, e.g., a memory module, in order to be able to properly mate with the slot 208. A user of the network 100 may carry the portable device 218. The security module 212 further comprises a non-contact communicating device 216 for communicating with the portable device 218.

When the user brings the portable device 218 into proximity of the printer 102 and hence the non-contact communicating device 216 of the security module 212 detects the presence and identity of the portable device 218. The secure printing software may then check the identity of the portable device 218 with an authorization/identification code and enable printing of the secure data if the identity of the portable device 218 matches the authorized identification code. As mentioned above, the printer 102 having the security module 212 cooperating with the portable device 218 and the secure printing software is provided with a secure printing feature.

Furthermore, it should be understood that the security module 212 with the non-contact communicating device 216 can be readily installed to any other printer through the slot on the circuit board such that the print is equipped with a secure printing feature. No other hardware changes are necessary to equip the printer with a secure printing feature. Therefore, the secure printing feature can be readily sold as an aftermarket product or a printer can be sold with the secure printing feature according to a particular customer order. Complications to the assembly process that occur when external contact input devices are utilized are thereby advantageously avoided.

In one embodiment of the present invention, the non-contact communicating device 216 of the security module 212 is a radio frequency (RF) reader which may be incorporated into a standard sized memory module, e.g., a DIMM. The RF reader 216 is able to identify the portable device 218 and/or an associated code of the portable device 218 by communicating via RF signals when a user brings the portable device 218 into proximity of the printer 102. Firmware code of the system is also updated to read an identification code read by the RF reader 216 of the security module 212, to compare the identification code to an authorized code for a particular secure document, and to permit printing of the secure document if the identification code is matched with the authorized code. Additional features in addition to the RF reader 216 are also added to the security module 212. Such features may include security features such as encryption and decryption features.

In some embodiments of the present invention, either a transmitter or receiver is located in the security module 212. The portable device 218 includes the other cooperating device (transmitter or receiver) so that the communication takes place between the security module 212 and the portable device 218 without physical contact between such devices.

The security module 212 according to another embodiment of the present invention includes both a transmitter and receiver. The transmitter of the security module 212 transmits an interrogation signal at a known frequency. The portable device 218 is configured to respond to the interrogation signal with a response signal representative of identifying data. The receiver of the security module 212 then detects this response signal and decodes the response signal as necessary to determine the identifying data provided by the portable device 218. An antenna is included in the security module 212 to assist with transmission of the interrogation signal and reception of the response signal.

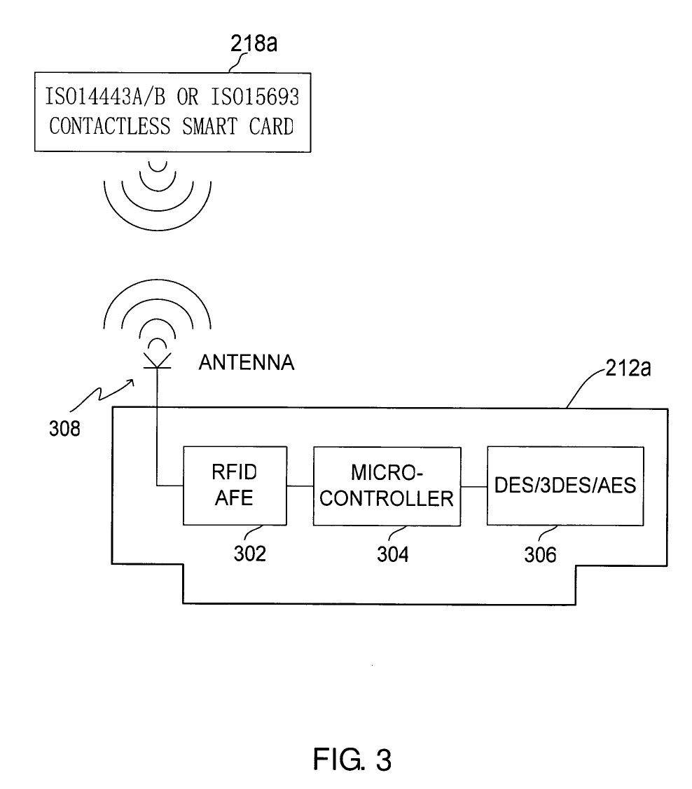

Referring to FIG. 3, a security module 212a and a portable device 218a according to another embodiment of the present invention are illustrated. The security module 212a is utilized in the printer 102 shown in FIG. 2 to permit non-contact communication between the security module 212a and the portable device 218a when the portable device 218a is brought by a user within a prescribed distance of the printer 102. The security module 212a includes an antenna 308, such as a 50 Ohm antenna, a radio frequency identification (RFID) analog front end (AFE) circuit 302, a micro-controller 304, such as an 8-bit micro controller, and a field programmable gate array (FPGA) to implement various encryption and decryption functions, such as the Data Encryption Standard (DES), the Advanced Encryption Standard (AES), and the Triple-Des (3DES).

The portable device 218a can be a transponder or tag incorporated in a smart card to cooperate with the RFID circuit 302. The portable device 218a includes an active or passive tag. An active tag has its own power source, e.g., a battery, and transmit a signal at regular intervals. An active tag typically works over a greater distance than a passive tag. A passive tag does not have its own power source and instead becomes activated when the passive tag encounters the electromagnetic field generated by a transmitter of the RFID circuit 302. The portable device 218a may be a contactless smart card, or be comply or be compatible with standards developed by the International Organization for Standardization (ISO) including ISO1443A or ISO15693.

The security module 212a shown in FIG. 3 may combine RFID identification features from the RFID/AFE circuit 302 and security features from the encryption and decryption circuit 306. The security module 212a may further include a base station operating at a particular frequency, e.g., 13.56 MHz and a field modulation switch.

The analog front end (AFE) circuit 302 according to one embodiment of the present invention is an integrated analog system for a 13.56 MHz RFID reader system. 0The AFE circuit 302 is highly versatile so it can be used in different RFID reader systems having different sub-carrier frequencies, e.g., including 212 kHz to 848 kHz hence covering ISO 14443 and ISO 15693 standards. The security module 212a is comply or be compatible with the ISO15693 standard hence enabling the security module 212a to detect the portable device 218a up to a range of about 3 meters. The RFID circuit 302 of the security module 212a may further include an integrated circuit (IC) transmitter that may generate 20 mW of output power into a 50 ohm (antenna) and is capable of utilizing a variety of modulation techniques including Amplitude-Shift Keying (ASK) and ON-OfKeying (OOK) digital modulation techniques.

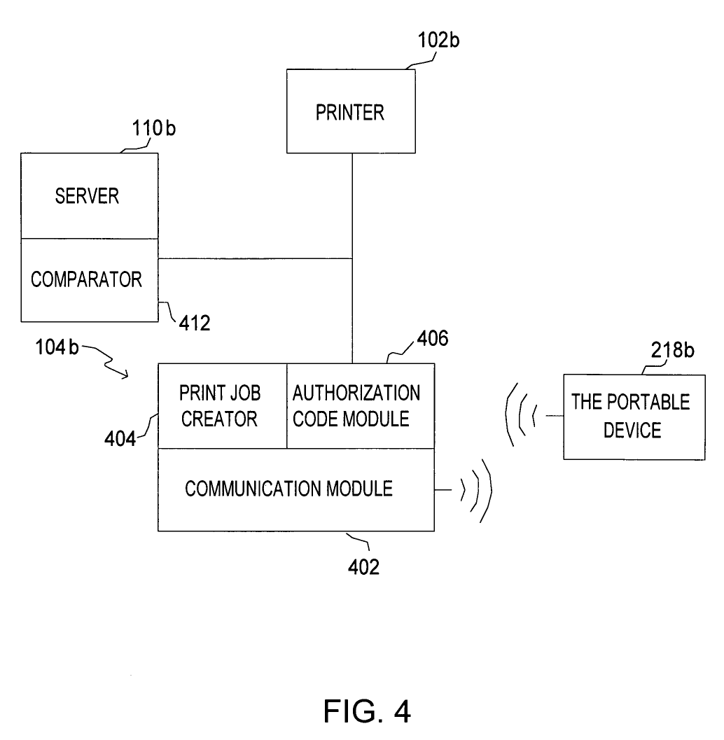

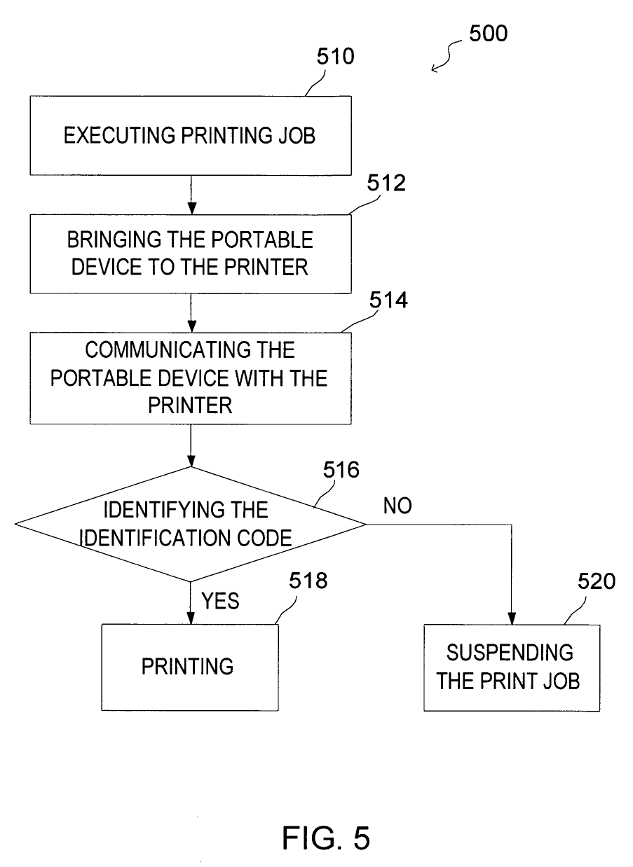

Furthermore, referring to FIG. 4, a workstation 104b according to one embodiment of the present invention is illustrated. The workstation 104b has a print job creator 404 for generating a secure print job. It will be apparent to those skilled in the art that the print job creator 404 can be software ruing on an operation system. When the secure print job is generated, the workstation 104b will request the user to provide the authorization code associated with the portable device 218b. For example, the portable device 218b is a contactless smart card. The workstation 104b has a communication module 402 for communicating with the portable device 218b through a RF signal and obtaining/receiving the identification code of the portable device 218b. The received identification code of the portable device 218b will be saved as the authorization code. The authorization code will be combined with the secure print job on an authorization code module 406 of the workstation 104b. The secure print job will be transmitted to the server 110b. Then, when the user brings the portable device 218b into proximity of the print 102, the identification code of the portable device 218b will be received by the printer 102b and be transmitted to the server 110b. A comparator 412 of the server 110b will be used to compare the received identification code and the authorization code of the secure print job such that the secure print job is printed if the received identification code is corresponding to the authorization code. In this case, those who do not have the portable device 218b will not enable printing of the secure print job. Alternatively, the user can enter or key in the authorization code which is associated with the identification code of the portable device 218.

According to another embodiment of the present invention, when the user log into the network 100, the network 100 will identify the user. The secure software has a list of the authorization codes which are associated with the identification codes of the portable devices 218 of authorized users. When the user generate a secure print job, the secure print job will be transferred to the printer 102. The secure print job will not be printed until the user brings the portable device 218 into proximity of the print 102 and the identification code of the portable device 218 matches one of the authorization codes in the list. In other words, in this case, the printer 102 will be enabled to print the secure print job by a group of authorized users.

Referring to FIG. 5, a method 500 for printing secure documents according to an embodiment of the present invention is illustrated. In a step 500, when using a workstation in the network to print secure documents, a user may execute the printing order in the workstation. The workstation transfers the print job of the secure document to the printer directly or via a server of the network. In a step 512, the user will bring the portable device to the proximity of the printer. In a step 514, the portable device is communicated with the printer by non-contact approaches, such RF signal. The identification code of the portable device will be transferred to the security module. In a step 516, the identification code of the portable device is compared with an authorization code to determine whether the identification code of the portable device is matched with the authorization code. If the identification code of the portable is not matched with the authorization code, go to a step 520 to stop printing. If yes, go to a step 518 to allow printing the secure print job.

In one embodiment, in the step 500, an authorization code which associated with the print job is generated and corresponding to an identification code of a portable device. The authorization code is attached to the print job. In the step 516, the identification code of the portable device is compared with the attached authorization code to allow printing the secure print job.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

1. A network comprising:
at least one workstation for generating a print job
a printer coupled to said at least one workstation; and
a portable device for communicating with said printer wherein said printer does not print said print job until said portable device provides authorization for printing said print job.

2. The network of claim 1, wherein said printer does not print said print job until the distance between said portable device and said printer is within a predetermined distance.

3. The network of claim 1, wherein said printer does not print said print job until the printer identifies said portable device.

4. The network of claim 3, wherein said portable device has an identification code, and said printer communicates with said the portable device via RF signal to obtain said identification code of said portable device for identifying said portable device.

5. The network of claim 4, wherein said print job has an authorization code, and the printer prints said print job when said identification code of said portable device corresponds to said authorization code of said print job.

6. The network of claim 1, wherein said printer further comprises:
a circuit board having a slot; and
a security module mating with said slot for communicating with said portable device for authorizing printing of said print job.

7. The network of claim 1, wherein said portable device is a contactless smart card.

8. The network of claim 1, wherein the communication of said portable device and said printer is comply with one of ISO1443A and ISO15693.

9. The network of claim 1, further comprising:
a secure printing software for identifying said portable device with said print job for authorizing said print job.

10. The network of claim 1, further comprising:
said portable device communicates with said printer via a radio frequency (RF) signal.

11. A printer comprising:
a printing module for printing;
a circuit board having a slot and coupled to said printing module for controlling said printing module; and
a security module mating with said slot of said circuit board for communicating with an external portable device for identifying said portable device with a print job so as to permit printing of said printing module.

12. The printer of claim 11, wherein said portable device has an identification code, and said security module communicates with said portable device via RF signal to obtain said identification code of said portable device such that said printer prints the print job if said identification code of said portable device is matched with a predetermined code.

13. The printer of claim 11, wherein said portable device is a contactless smart card.

14. The printer of claim 11, wherein said slot of said circuit board is a memory slot.

15. The printer of claim 12, further comprising:
a comparator for comparing said identification code and said predetermined code.

16. The printer of claim 12, further comprising:
an authorization code module for generating said predetermined code that is associated with said identification code.

17. A method for printing a secure document comprising:
creating a printing job of said secure document;
assigning an authorization code to said printing job;
associating said authorization code with an identification code of a portable device to authorize printing of said printing job;
sending said printing job to a printer with said authorization code and said identification code; and
permitting printing of said print job when said portable device is identified.

18. The method of claim 17, further comprising:
transferring said printing job through a network.

19. The method of claim 17, wherein said portable device is a contactless smart card.

20. The method of claim 17, wherein in the step of communicating, said portable device communicates with said printer via a radio frequency (RF) signal.

21. The method of claim 17, wherein in the step of identifying further comprises:
establishing communication between said portable device and said printer;
obtaining said identification code from said portable device; and
comparing said identification code obtained from said portable device with said authorization code, wherein said printing job is authorized when said identification code obtained from said portable device and said authorization code match.

22. The method of claim 21, wherein said permitting printing:
establishing communication between said portable device and said printer to obtain said identification code; and
printing said printing job when said authorization code and said identification code match.

23. A workstation for generating a printing job to a printer, comprising:
a print job creator for generating a print job;
a communication module for communicating with an external portable device having an identification code so as to obtain said identification code of said portable device; and
an authorization code module for generating an authorization code associated with said identification code and for combining said print job with said authorization code and said identification code for transmitting said print job to an external printer, wherein said printer prints said print job when the distance between said portable device and said printer is within a predetermined distance, and when the portable device is properly identified with said authorization code.

24. The workstation of claim 23, wherein said print has a security module for communicating with said portable device and receiving said identification code of said portable device, and said print job is transmitted to said printer through a network which has a comparator for comparing said identification code of said portable device and said authorization code of said print job such that said print job does not print the print job unless said identification code of said portable device and said authorization code of said print job match.
